(19) United States
(12) Patent Application Publication
(10) Pub. No.: US 2011/0197931 A1
(43) Pub. Date: Aug. 18, 2011

(54) APPARATUS FOR WASHING A WORKPIECE

(75) Inventors: Kae Jeng Ng, Selangor (MY); Kien Hui Liang, Kuala Lumpur (MY); Kien Yew Liang, Kuala Lumpur (MY)

(73) Assignee: INVENPRO (M) SDN. BHD., Selangor Darul Ehsan (MY)

(21) Appl. No.: 13/056,603

(22) PCT Filed: Jul. 31, 2009
(86) PCT No.: PCT/MY2009/000107

§ 371 Date: Apr. 13, 2011

(30) Foreign Application Priority Data
Jul. 31, 2008 (MY) PI 20082877

(51) Int. Cl. B08B 3/04; B08B 3/10

(52) U.S. Cl. 134/104.4; 134/104.2

(57) ABSTRACT

The present invention relates to an apparatus (100) for washing a workpiece such as wafers, PC boards, hybrid circuits, precision mechanical or electromechanical components, optical instruments, medical devices or the like. Preferably, the apparatus (100) of the present invention can be used for washing disk drive components that have a substantially flat disc shape. The simple and easy to maintain structure of the present apparatus provides an uni-directional flow of washing liquid within the apparatus to remove contaminants from the surface of a workpiece in a submerged condition under streams of the washing liquid. The uni-directional flow of the washing liquid is achieved via a means which pumping a flow of washing liquid into the inlet and simultaneously extracting a flow of washing liquid out of the outlet of the apparatus (100). The uni-directional flow of the washing liquid is capable of preventing the removed contaminants from re-depositing onto the surface of the workpiece that has been cleaned.

### FIELD OF THE INVENTION

The present invention relates to an apparatus and a method for washing a workpiece particularly a media or substrate disk in a submerged condition under streams of a washing liquid.

### BACKGROUND OF THE INVENTION

Hard disk drives for computer memory are mass produced through automated manufacturing processes. There are various unit processes involved in the production of a hard disk drive. During these unit processes, residue chemicals, small particles and contaminants which are attached to the surface of a disk need to be removed. Therefore, an aspect of this automated manufacturing process is washing a disk one or more times during the manufacturing process.

There are several processing steps that many automated disk washing machines have in common. The first is a loading means where unwashed disks may be readily loaded into the disk washing machine. The second is a washing station where the disks are washed with a cleaning solution. The third is a rinsing area where the disks are rinsed. The fourth is a drying station where the disks are dried.

These conventional washing machines have certain shortcomings and problems. One of them is that the workpiece is being transferred directly from a washing station into a rinsing area. In this situation, contaminations that occurred in the washing station or during transit are directly brought into the rinsing area when the workpiece is moved and soaked in the rinsing tank with the cleansing solution. Furthermore, the use of more than one station for washing and rinsing is inefficient as it increases the number of components and also the size of the apparatus. Further, there are ultrasonic cleansing apparatus which removes contaminants by irradiating a workpiece in a cleaning tank with ultrasonic waves. However, the ultrasonic waves acting on each workpiece is usually not uniform and therefore contaminants cannot be effectively or consistently removed in some cases.

Besides, various running water type washing machines have been known in the art and there are a number of patent documents that disclose such machines, for examples, laid-open Japanese Utility Model specification S61-130389, laid-open Japanese patent specification S64-63086 and the U.S. Pat. No. 5,709,235. The washing machine disclosed in the U.S. Pat. No. 5,709,235 attempted to create a laminar flow within the washing vessel via the use of a pressurised liquid feed section, multiple regular plates and a high resistance membrane positioned at the flow passage. The structure of this invention is complicated and the use of the pressurised liquid feed section and the high resistance membrane increased the production costs. Furthermore, this invention requires a longer washing vessel for liquid to stream effectively whereby it inevitably increases the size of the article.

### SUMMARY OF THE INVENTION

The present invention aims to provide an apparatus which has a simpler structure yet can effectively remove contaminants of a workpiece in a cost and time saving approach.

The apparatus of the present invention can be used during manufacturing processes for washing of various workpiece including various devices or parts such as wafers, PC boards, hybrid circuits, precision mechanical or electromechanical components, optical instruments, medical devices or the like. Preferably, the apparatus of the present invention can be used for washing disk drive components having a substantially flat disc shape.

The apparatus of the present invention is able to remove contaminants from the surface of a workpiece a in a submerged condition under an uni-directional flow of a running washing liquid.

The apparatus of the present invention which enables the washing liquid flowing in an uni-direction from an inlet of the washing tank to an outlet of the washing tank prevents the contaminants that have been removed from the surface of a workpiece from re-depositing onto the workpiece that has been cleaned.

When the contaminants are removed from the workpiece, the uni-directional flow carries the contaminants away from the workpiece and discharged them through the outlet of the washing tank.

An apparatus (100) of the present invention for removing contaminants from the surface of a workpiece by using a washing liquid comprises

a) a washing tank (102) for washing said workpiece in a submerged condition under streams of said washing liquid;
b) a washing liquid supply chamber (110) attached to a first end of said washing tank (102) for supplying said washing liquid into said washing tank (102);
c) a washing liquid discharge chamber (120) attached to a second end of said washing tank (102) for discharging used washing liquid from said washing tank (102); and
d) at least a flow regulating plate (104) mounted at an inlet of said washing tank (102);
wherein said apparatus further comprises a means to create an uni-directional flow between an inlet and an outlet of said washing tank (102) by positive pumping said washing liquid into the washing tank (102) and positive extracting used washing liquid out of said washing tank (102).

According to one embodiment of the present invention, the means to create an uni-directional flow between an inlet and an outlet of said washing tank (102) is at least a pump connected in series with said washing liquid supply chamber (110), said washing tank (102), and said washing liquid discharge chamber (120) to form a circuit. Alternatively, the means to create an uni-directional flow between an inlet and an outlet of said washing tank (102) is at least a pump connected to said washing liquid supply chamber (110) to pump or push said washing liquid into said washing liquid supply chamber (110) and at least a pump connected to said washing liquid discharge chamber (120) to extract or pull the washing liquid out of said washing liquid discharge chamber (120).

The flow of the washing liquid is pumped into and extracted out of said washing tank (102) simultaneously and continuously. The amount of the washing liquid being pumped into said washing liquid supply chamber (110) is substantially equal to the amount of the washing liquid being extracted out of said washing liquid discharge chamber (120).

Other features, according to other embodiments of the present invention, will be apparent from the accompanying drawings and from the detailed descriptions that follows.

### BRIEF DESCRIPTION OF THE DRAWINGS

In order to provide a better illustration, the present invention will now be described with reference to the accompanying drawings in which:

FIG. 1 shows a perspective view of an apparatus according to the present invention;

FIG. 2 shows another perspective view of an apparatus according to the present invention;

FIG. 3 shows a perspective view of an apparatus according to the present invention with one wall being removed;

FIG. 4 shows a cross sectional view of an apparatus according to the present invention.

### DETAILED DESCRIPTION OF THE PREFERRED EMBODIMENTS

The terms “pumped into” and “extracted out” as used in the present invention refer to a method to “push and pull” the washing liquid into and out of the washing tank by using at least a pump connected to the apparatus.

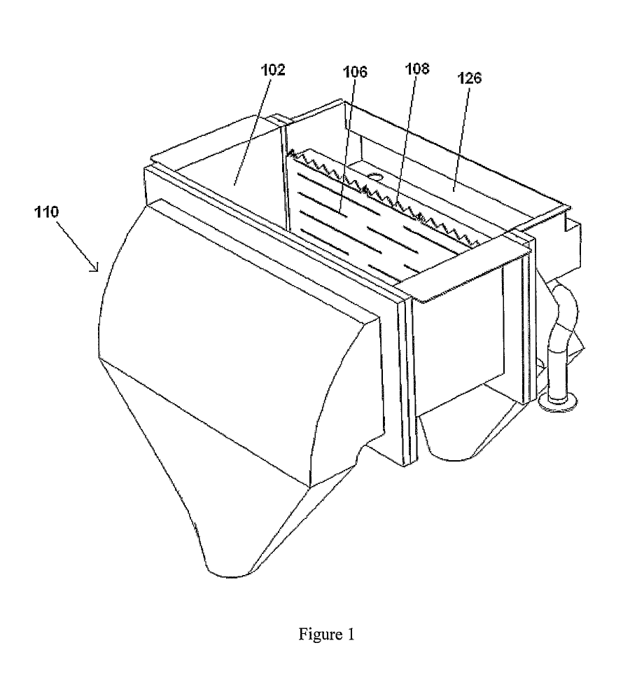

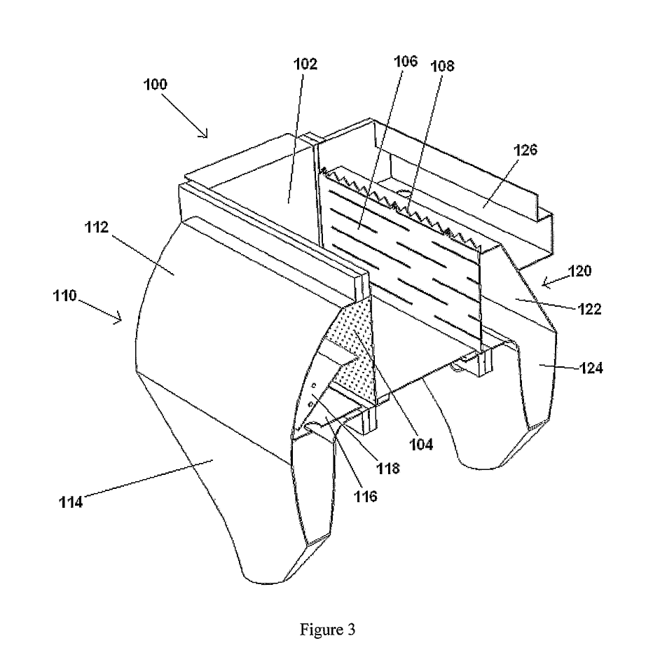

Described herein is an apparatus for removing contaminants from the surface of a workpiece during manufacturing processes. Referring to FIGS. 1 and 3, the apparatus (100) for removing contaminants from the surface of a workpiece according to an embodiment of the present invention comprises a washing tank (102). The washing tank (102) is where a workpiece to be washed will be placed. Inside the washing tank (102), there is a securing means (not shown) for securing the workpiece in its position during the washing process so that the workpiece to be washed is secured in place under the streams of washing liquid. The washing tank (102) of the present invention is preferably a four-sided tank in the shape of a square or a rectangular. At one end of the washing tank (102), a washing liquid supply chamber (110) is attached to it for supplying the washing liquid into the washing tank (102). At the other end opposite to the end where the washing liquid supply chamber (110) is attached, a washing liquid discharge chamber (120) is attached to it for discharging the used washing liquid from the washing tank (102).

As shown in the FIGS. 1 to 3, the washing liquid supply chamber (110) is a closed chamber which flares out gradually to connect to the inlet of said washing tank (102). Preferably, the washing liquid supply chamber (110) is a closed diffuser funnel manifold having a substantially vertical funnel shape (114) and is upwardly flares out to form a wider upper part (112) that is connected at its side wall to the inlet of said washing tank (102). The washing liquid discharge chamber (120) is substantially a mirror image of the washing liquid supply chamber (110) with the centre vertical parting line of the washing tank (102) as the mirror, i.e. it has a vertical funnel shape (124) and is upwardly flares out to form a wider upper part (122) that is attached to the outlet of the washing tank (102). The washing liquid supply chamber (110), washing tank (102) and washing liquid discharge chamber (120) are preferably be assembled in an inverted-U shape with the washing tank positioned in a substantially horizontal position located at the peak of the inverted-U.

The washing liquid as referred to herein includes treated water such as pure water, ultra-pure water, a chemical solution or any other appropriate liquid.

The apparatus of the present invention further comprises a means to create an uni-directional flow between an inlet and an outlet of the washing tank (102) by positive pumping said washing liquid into the washing tank (102) and positive extracting used washing liquid out of said washing tank (102).

In one embodiment of the present invention, the means to create an uni-directional flow between an inlet and an outlet of said washing tank (102) is at least a pump connected in series with said washing liquid supply chamber (110), said washing tank (102), and said washing liquid discharge chamber (120) to form a circuit whereby the flow of said washing liquid is being pumped into and extracted out of said washing tank (102) simultaneously and continuously to form an uni-directional flow between the inlet and outlet of the washing tank (102)

In this embodiment, the circuit may possess another function to recycle the washing liquid. This recycling circuit may further comprise a filtering means located at the upstream of said pump to filter the washing liquid. The details of this recycling circuit will be further explained in the subsequent part of this description.

In another embodiment, the means to create an uni-directional flow between an inlet and an outlet of said washing tank (102) is at least a pump connected to said washing liquid supply chamber (110) to pump said washing liquid into said washing liquid supply chamber (110) and at least a pump connected to said washing liquid discharge chamber (120) to extract the washing liquid out of said washing liquid discharge chamber (120).

In both embodiments, the pumping and extracting of the washing liquid into and out of the washing tank (102) are carried out continuously and simultaneously. The amount of the washing liquid being pumped into the washing liquid supply chamber (110) is substantially equal to the amount of the washing liquid being extracted out of the washing liquid discharge chamber (120).

According to the present invention, a flow regulating plate (104) is mounted at the inlet of the washing tank (102). The flow regulating plate (104) is mounted in a position which will cut across the entire flow passage of washing liquid into the washing tank (102). To enhance the performance of the apparatus, more than one perforated flow regulating plate may be mounted at the inlet of the washing tank (102).

The afore-mentioned flow regulating plate (104) has a plurality of water passage apertures which are spaced apart in a pre-determined interval. The apertures are preferably circular in shape but it can be fabricated in other geometric configurations, for example squares, ovals, rectangles or other suitable shapes.

If more than one perforated flow regulating plates are used, the construction of the perforated flow regulating plates may be the same or they may be different.

The apparatus (100) of the present invention may further comprise at least a baffle plate to regulate the washing liquid. The baffle plate (116) is preferably installed within the washing liquid supply chamber (110) at the upstream of the flow regulating plate (104). Preferably, the baffle plate (116) is installed between the wider upper part (112) and the vertical funnel (114) and is substantially perpendicular to the flow regulating plate (104). The baffle plate (116) is also perforated with a plurality of water passage apertures. The purpose of the baffle plate (116) is to reduce the velocity of the incoming washing liquid and equalise the pressure of the washing liquid.

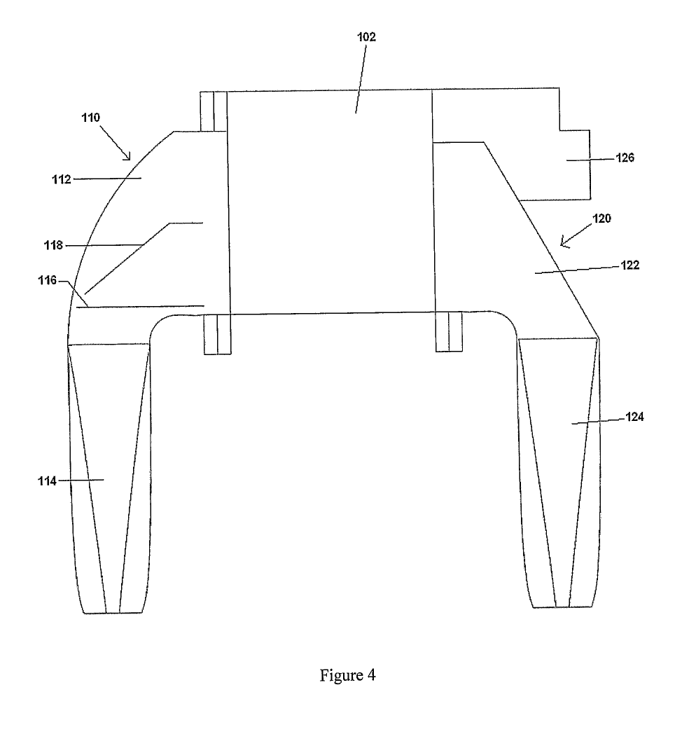

If necessary or desirable, more than one baffle plates may be provided at the upstream of the perforated flow regulating plate (104). In the event that more than one baffle plates are used, the construction of the baffle plates may be the same or different. As illustrated in FIGS. 3 and 4 as one of the embodiments, a second baffle plate (118) is provided between the first baffle plate (116) and the flow regulating plate (104). Same as the flow regulating plate (104) and the first baffle plate (116), the second baffle plate (118) is perforated with a plurality of apertures. Preferably, one end of the second baffle plate (118) is placed at the middle part of the flow regulating plate (104) and is slanting downwardly with a free moving end.

The apparatus (100) of the present invention may further comprise a second flow regulating plate (106) at the outlet of said washing tank (102), covering the entire flow passage from the washing tank (102) into said washing liquid discharge chamber (120). The second flow regulating plate (106) has a plurality of slits for the discharge of used washing liquid and may help to create and maintain the uni-directional flow within the apparatus.

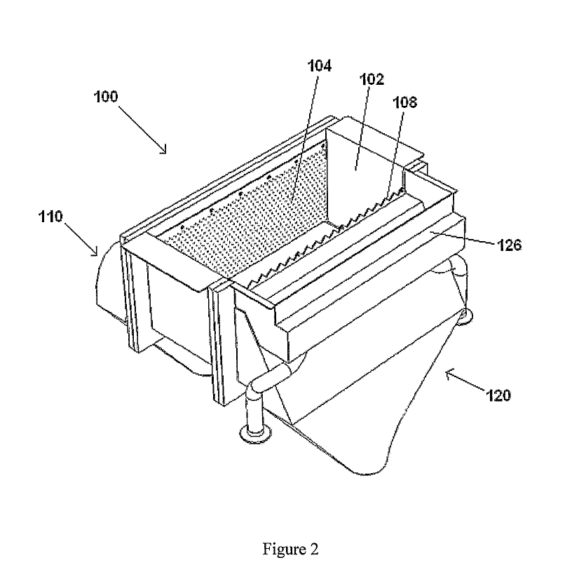

According to the present invention, an overflow means (108) is extends from the top edge of the second flow regulating plate (106) at the outlet of said washing tank (102). As seen in the FIGS. 2 and 3, the overflow means (108) has a plurality of slots in the form of notches along its top edge.

The overflow means (108) enable a continuous conveyance of washing fluid through the washing tank (102). This ensures a uniform washing liquid level during operation in a simple and economical manner and thus ensures an uni-directional flow of the washing liquid within the washing tank (102). The overflow means (108) is surrounded by a substantially closed overflow chamber (126) adjacent to the washing liquid discharge chamber (120). When the washing liquid in the washing tank (102) exceeds its maximum level, the washing liquid will escape through the overflow means (108) into said overflow chamber (126).

During operation, the workpiece to be washed is carried by a mechanic arm (not shown) into the washing tank (102) and is secured in place via the use of the securing means within the washing tank (102). The washing liquid is then supplied into the apparatus through a spout pipe (not shown) connected to at the bottom of the washing liquid supply chamber (110). A constant flow of the washing liquid is homogeneously upwardly directed from the bottom of the vertical funnel (114) of the washing liquid supply chamber (110) into the wider upper part (112) via the baffle plates (116, 118). With the existence of the baffle plates, the velocity of the washing liquid is reduced and the washing liquid is spread to the edges or sides of the wider upper part (112) of the washing liquid supply chamber (110). The washing liquid is then introduced via the perforated flow regulating plate (104) into the washing tank (102) until the washing liquid flows over the notches of said overflow means (108) into the overflow chamber (126). While washing liquid is continuously introduced in this manner into the washing tank (102), the used washing liquid is extracted out of the washing liquid discharge chamber (120) so that an uni-directional flow of the washing liquid within the washing tank is produced and maintained.

The perforated regulating plate (104) causes the washing liquid to distribute and flow forward evenly through perforations and across the washing tank (102). The even flow of the washing liquid through the perforations results in a substantially parallel flow pattern and thus an uni-directional flow within the washing tank (102).

To ensure a constant uni-directional flow of the washing liquid in the apparatus, the flow of the washing liquid will be maintained preferably at a substantially high flow rate.

The uni-directional washing liquid flowing from the inlet of the washing tank (102) to the outlet of the washing tank (102) removes contaminants from the surface of the workpiece placed within said washing tank (102). The contaminants removed from the workpiece are carried away from the workpiece and discharged together with the used washing liquid into the washing liquid discharge chamber (120). The uni-directional flow of washing liquid within the washing tank (102) prevents the removed contaminants from re-entering into the flow of washing liquid and re-depositing onto the surface of the washed workpiece. An important feature of the present invention is that the pressure within said washing tank (102) and said washing liquid supply chamber (110) are substantially equal. Therefore, the washing liquid in the washing liquid supply chamber (110) are not pressurized as opposed to the conventional methods.

In the preferred embodiment of the present invention, the used washing liquid discharged from the washing liquid discharge chamber (120) may be re-circulated and re-use through a recycling circuit which is provided between the washing liquid discharge chamber (120) and the washing liquid supply chamber (110). The recycling circuit comprises a flow passage for collecting the used washing liquid discharged from the washing liquid discharge chamber (120), a pump to extract the used washing liquid out of the washing liquid discharge chamber (120) and to pump the collected washing liquid from the flow passage into the washing liquid supply chamber (110), and a filtering means located at the upstream of said pump to filter the washing liquid. The used washing liquid collected from the washing liquid discharge chamber (120) is channeled into the flow passage and filtered through the filtering means to eliminate the contaminants before it is pumped or pushed into the washing liquid supply chamber (110) for reuse.

While the washing liquid is being circulated in the apparatus, a pre-determined amount of fresh washing liquid is constantly introduced into the apparatus to enhance the contaminants elimination ability. When excessive washing liquid is introduced into the apparatus, the excess amount of washing liquid will flow out of the apparatus through the overflow means. The contaminants removed from the surface of the workpiece are thereby discharged out of the apparatus through the notches of the overflow means.

Preferably, the washing liquid supply chamber (110), washing tank (102), washing liquid discharge chamber (120) and the recycling circuit are constructed as one integral structure so that the liquid discharged out of the apparatus and the liquid introduced into the apparatus are equal and thus further ensures the uni-directional effect in the apparatus.

If desired, the washing tank of the present invention may be further equipped with an ultrasonic unit. The ultrasonic unit enhances the washing ability by irradiating the workpiece with ultrasonic waves and facilitates the effective removal of contaminants therefrom.

The foregoing descriptions of specific embodiments of the present invention have been presented for the purposes of illustration and description. They are not intended to be exhaustive or to limit the invention to the precise forms disclosed, and obviously many modifications and variations are possible. The embodiments were chosen and described as they best explain the principles of the invention and its practical application, to enable others skilled in the art to best utilize the invention and various embodiments with various modifications as are suited to the particular intended objectives. It is intended that the scope of the invention be defined by the claims appended hereto and their equivalents.

1-21. (canceled)

22. An apparatus (100) for removing contaminants from the surface of a workpiece by using a washing liquid comprises
a) a washing tank (102) for washing said workpiece in a submerged condition under streams of said washing liquid;
b) a washing liquid supply chamber (110) attached to a first end of said washing tank (102) for supplying said washing liquid into said washing tank (102);
c) a washing liquid discharge chamber (120) attached to a second end of said washing tank (102) for discharging used washing liquid from said washing tank (102);
d) at least a flow regulating plate (104) mounted at an inlet of said washing tank (102);
e) an overflow chamber (126) adjacent to said washing liquid discharge chamber (120) for receiving washing liquid that escaped from said washing tank (102); and
f) at least a baffle plate (116) installed within said washing liquid supply chamber (110) substantially perpendicular to said flow regulating plate (104);
wherein said apparatus further comprises a means to create an uni-directional flow between an inlet and an outlet of said washing tank (102) by positive pumping said washing liquid into the washing tank (102) and positive extracting used washing liquid out of said washing tank (102);
wherein said overflow chamber (126) having an outlet connected to the outlet of the washing liquid discharge chamber (120) for directing the overflow washing liquid into the pumping means.

23. An apparatus (100) for removing contaminants from the surface of a workpiece by using a washing liquid according to claim 22 wherein the pressure within said washing tank (102) and said washing liquid supply chamber (110) are substantially equal.

24. An apparatus (100) for removing contaminants from the surface of a workpiece by using a washing liquid according to claim 22 wherein said means to create an uni-directional flow between an inlet and an outlet of said washing tank (102) is at least a pump connected in series with said washing liquid supply chamber (110), said washing tank (102), and said washing liquid discharge chamber (120) to form a circuit whereby the flow of said washing liquid is being pumped into and extracted out of said washing tank (102) simultaneously and continuously in a manner where the amount of said washing liquid being pumped into said washing tank (102) is substantially equal to the amount of the used liquid being extracted out of said washing tank (102).

25. An apparatus (100) for removing contaminants from the surface of a workpiece by using a washing liquid according to claim 24 wherein said circuit further comprises a filtering means located at the upstream of said pump to filter the washing liquid.

26. An apparatus (100) for removing contaminants from the surface of a workpiece by using a washing liquid according to claim 22 wherein said means to create an uni-directional flow between an inlet and an outlet of said washing tank (102) is at least a pump connected to said washing liquid supply chamber (110) to pump said washing liquid into said washing liquid supply chamber (110) and at least a pump connected to said washing liquid discharge chamber (120) to extract the washing liquid out of said washing liquid discharge chamber (120), whereby the amount of the washing liquid being pumped into said washing liquid supply chamber (110) is substantially equal to the amount of the washing liquid being extracted out of said washing liquid discharge chamber (120).

27. An apparatus (100) for removing contaminants from the surface of a workpiece by using a washing liquid according to claim 22 wherein said washing liquid discharge chamber (120) is attached to the end opposite to said first end.

28. An apparatus (100) for removing contaminants from the surface of a workpiece by using a washing liquid according to claim 22 wherein said flow regulating plate (104) is mounted at the inlet of said washing tank (102) in such a way that it encloses the entire flow passage into said washing tank (102).

29. An apparatus (100) for removing contaminants from the surface of a workpiece by using a washing liquid according to claim 22 wherein said flow regulating plate (104) comprises a plurality of water passage apertures.

30. An apparatus (100) for removing contaminants from the surface of a workpiece according to claim 22 wherein said apparatus (100) further comprises a second flow regulating plate (106) positioned at the outlet of said washing tank (102) and covering the entire flow passage into said washing liquid discharge chamber (120).

31. An apparatus (100) for removing contaminants from the surface of a workpiece according to claim 30 wherein said second flow regulating plate (106) comprises a plurality of slits.

32. An apparatus (100) for removing contaminants from the surface of a workpiece by using a washing liquid according to claim 22 wherein said washing liquid supply chamber (110) is a closed chamber which flares out gradually to connect to the inlet of said washing tank (102).

33. An apparatus (100) for removing contaminants from the surface of a workpiece by using a washing liquid according to claim 32 wherein said washing liquid supply chamber (110) is a closed diffuser funnel manifold having a substantially vertical funnel shape (114) and is upwardly flares out to form a wider upper part (112) wherein the side wall of said wider upper part is attached to the inlet of said washing tank (102);

34. An apparatus (100) for removing contaminants from the surface of a workpiece according to claim 22 wherein said liquid supply chamber (110) further comprises a second baffle plate (118) installed between said first baffle plate (116) and said flow regulating plate (104).

35. An apparatus (100) for removing contaminants from the surface of a workpiece according to claim 22 wherein said second baffle plate (118) installed between said first baffle plate (116) and said flow regulating plate (104) is slanting from the middle part of said flow regulating plate (104) with a free moving end.

36. An apparatus (100) or removing contaminants from the surface of a workpiece according to claim 22 wherein said baffle plate (116, 118) is perforated with a plurality of water passage apertures.

37. An apparatus (100) for removing contaminants from the surface of a workpiece by using a washing liquid according to claim 22 wherein said washing liquid discharge chamber (120) is substantially a mirror image of said washing liquid supply chamber (110) for the discharge of used washing liquid from said washing tank (102).

38. An apparatus (100) for removing contaminants from the surface of a workpiece according to claim 22 wherein said apparatus (100) further comprises an overflow means (108) extending from the top edge of said second flow regulating plate (106) such that the washing liquid will escape from the washing tank through said overflow means (108) when said washing liquid exceeds the maximum level of said washing tank (102).

39. An apparatus (100) for removing contaminants from the surface of a workpiece according to claim 38 wherein said overflow means (108) is a plurality of slots in the form of notches at the top edge of said second flow regulating plate (106).

40. An apparatus (100) for removing contaminants from the surface of a workpiece according to claim 22 wherein said washing tank (102) is equipped with an ultrasonic unit for the application of ultrasound energy.
